(19) United States
(12) Patent Application Publication
(10) Pub. No.: US 2014/0077932 A1
(43) Pub. Date: Mar. 20, 2014

(54) METHOD AND SYSTEM FOR ALERTING AN OWNER OF A LOST ANIMAL

(71) Applicant: VISAGE The Global Pet Recognition Company Inc., Vancouver (CA)

(72) Inventor: Philip Rooyakkers, Vancouver (CA)

(21) Appl. No.: 14/029,790

(22) Filed: Sep. 17, 2013

Related U.S. Application Data
(60) Provisional application No. 61/702,124, filed on Sep. 17, 2012.

(51) Int. Cl. G08B 5/22

(52) U.S. Cl. CPC G08B 5/222
USPC 340/7.51

(57) ABSTRACT

Methods, systems, and techniques for alerting an owner of a lost animal involve receiving found animal identification information describing the animal from a person who has found the lost animal; attempting to retrieve a reference profile of the animal by using the found animal identification information to search a database that includes the reference profile; when the reference profile is retrieved, contacting the owner of the animal using the animal ownership information; and when the reference profile is not retrieved, broadcasting a message to attempt to alert the owner of the animal. The reference profile includes animal ownership information and reference animal identification information that overlaps with the found animal identification information. Methods, systems, and techniques for entering reference animal identification information, for searching for an animal that is lost, for obtaining found animal identification information, and for searching a database may also be involved in alerting the owner.

### CROSS-REFERENCE TO RELATED APPLICATION

This application claims priority pursuant to 35 USC §119(e) to U.S. patent application assigned Ser. No. 61/702,124 and filed on Sep. 17, 2012, the entirety of which is hereby incorporated by reference herein.

### TECHNICAL FIELD

The present disclosure is directed at methods, systems, and techniques for alerting an owner of a lost animal. More particularly, the present disclosure is directed at methods, systems, and techniques for alerting an owner that someone has found the lost animal.

### BACKGROUND

According to the American Humane Society, approximately 5,000,000 to 7,000,000 animals enter animal shelters annually in the United States. Of these, approximately 3,000,000 to 4,000,000 are euthanized. Shelter intakes are about evenly divided between those animals relinquished by owners to the shelters and those animals that animal control captures. Many of the animals that animal control captures are lost pets. According to the National Council on Pet Population Study and Policy, less than 2% of lost cats and only around 15% to 20% of lost dogs are reunited with their owners.

Given the large number of lost animals in the United States alone, there exists a continued need for methods, systems, and techniques for alerting owners of lost animals that their animals have been found. Research and development accordingly continue in this field.

### SUMMARY

According to a first aspect, there is provided a method for alerting an owner of a lost animal, the method comprising receiving found animal identification information describing the animal from a person who has found the lost animal; attempting to retrieve a reference profile of the animal by using the found animal identification information to search a database that comprises the reference profile, wherein the reference profile comprises animal ownership information and reference animal identification information; when the reference profile is retrieved, contacting the owner of the animal using the animal ownership information; and when the reference profile is not retrieved, broadcasting a message to attempt to alert the owner of the animal.

Broadcasting the message may comprise placing postings about the animal on a social media website.

The method may further comprise receiving a photo of the animal; checking to see whether the photo satisfies photo acceptance criteria; if the photo satisfies the photo acceptance criteria, generating the reference animal identification information from the photo; and if the photo does not satisfy the photo acceptance criteria, requesting another photo.

The method may further comprise, following generating the reference animal identification information and prior to receiving the found animal identification information requesting confirmation that the reference animal identification information is acceptable; and if the reference animal identification information is acceptable, adding the reference animal identification information to the reference profile of the animal.

The method may further comprise receiving a notification that the animal is lost; and adding the animal to a lost list comprising a list of animals that have been lost, wherein the lost list comprises animals whose reference profiles are stored in the database.

Searching the database may comprise searching the lost list to find the reference profile of the animal in the lost list.

The method may further comprise obtaining photos of lost animals from a social network website (“social network photos”); generating the reference animal identification information from the social network photos; generating a social network list comprising a list of animals that have been lost and that have reference profiles populated with the reference animal identification information generated from the social network photos. Searching the database may comprise searching the social network list to find the reference profile in the social network list that comprises the found animal identification information.

Obtaining the social network photos may comprise data scraping the photos from a social network website.

The method may further comprise forwarding responses to the postings to the owner.

Obtaining the found animal identification information may comprise receiving a photo of the animal; checking to see whether the photo satisfies photo acceptance criteria; if the photo satisfies the photo acceptance criteria, generating the found animal identification information from the photo; and if the photo does not satisfy the photo acceptance criteria, requesting another photo.

The method may further comprise, following generating the found animal identification information requesting confirmation that the found animal identification information is acceptable; and if the found animal identification information is acceptable, using the found animal identification to search the database.

The found animal identification information may comprise identifying characteristics selected from the group consisting of: animal location, animal type, animal breed, animal fur color, animal eye color, animal size, animal sex, animal height, animal weight, and biometric information relating to pet facial features.

The biometric information may be selected from the group consisting of: the distance between the center of the animal's eyes, the distance between the outer and inner edges of the animal's eyes, the distance between the inner edge of the animal's eyes and tip of its nose, the distance between the center of the animal's eyes to the top of its head, the shape of the animal's head, the distance between where the animal's ears meet on its head.

Contacting the owner of the animal may comprise sending a message to a mobile communications device registered with the owner.

Contacting the owner of the animal may comprise posting a message to a social network website.

The database may comprise an online database from a social network website.

Searching the database may comprise filtering reference profiles in the database by all categories of the animal identification information.

Searching the database may comprise filtering reference profiles in the database by successively decreasing categories of the animal identification information until the reference profile of the animal is identified.

According to another aspect, there is provided a method for entering reference animal identification information of an animal. The method comprises receiving a photo of the animal; checking to see whether the photo satisfies photo acceptance criteria; if the photo satisfies the photo acceptance criteria, generating the reference animal identification information from the photo; and if the photo does not satisfy the photo acceptance criteria, requesting another photo.

The reference animal identification information may comprise non-biometric information.

The reference animal identification information may comprise biometric information.

Following generating the reference animal identification information and prior to receiving the found animal identification information, the method may further comprise requesting confirmation that the reference animal identification information is acceptable; and if the reference animal identification information is acceptable, adding the reference animal identification information to the reference profile of the animal.

According to another aspect, there is provided a method for searching for an animal that is lost. The method comprises receiving a notification that the animal is lost; and adding the animal to a lost list comprising a list of animals that have been lost, wherein the lost list comprises animals whose reference profiles are stored in a database.

The database may be searched by searching the lost list to find a reference profile in the lost list of the animal.

The method may also comprise obtaining photos of lost animals from a social network website (“social network photos”); generating reference animal identification information from the social network photos; generating a social network list comprising a list of animals that have been lost and that have reference profiles populated with the reference animal identification information generated from the social network photos, and searching the database by performing a method comprising searching the social network list to find the reference profile in the social network list that comprises the found animal identification information.

Obtaining the social network photos may comprise data scraping the photos from a social network website.

The method may also comprise placing postings about the animal on a social media website; and forwarding responses to the postings to the owner.

According to another aspect, there is provided a method for obtaining found animal identification information. The method comprises receiving a photo of the animal; checking to see whether the photo satisfies photo acceptance criteria; if the photo satisfies the photo acceptance criteria, generating the found animal identification information from the photo; and if the photo does not satisfy the photo acceptance criteria, requesting another photo.

The found animal identification information may comprise non-biometric or biometric information.

The method may also comprise, following generating the found animal identification information: requesting confirmation that the found animal identification information is acceptable; and if the found animal identification information is acceptable, using the found animal identification to search a database.

According to another aspect, there is provided a method for searching a database. The method comprises filtering reference profiles in the database by all categories of animal identification information and returning reference profiles that remain following the filtering.

Searching the database may also comprise filtering reference profiles in the database by successively decreasing categories of animal identification information until the reference profile of the animal is identified.

According to another aspect, there is provided a system for alerting an owner of an animal, the system comprising a processor; a database communicatively coupled to the processor and having stored therein a reference profile of the animal, wherein the database is searchable using found animal identification information and wherein the reference profile comprises animal ownership information and reference animal identification information; and a memory communicatively coupled to the processor and having encoded thereon statements and instructions to cause the processor to perform any of the foregoing methods or suitable combinations thereof.

According to another aspect, there is provided a non-transitory computer readable medium having encoded thereon statements and instructions to cause a processor to perform any of the foregoing methods or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 shows a system for alerting an owner of an animal, according to one embodiment.

FIG. 2 shows a method for alerting an owner of an animal, according to another embodiment.

FIG. 3 shows a method for alerting an owner of animal, according to a third embodiment.

FIG. 4 shows a method for entering reference animal identification information into the system of FIG. 1, according to another embodiment.

FIG. 5 shows a method for searching for an animal that is lost using the system of FIG. 1, according to another embodiment.

FIGS. 6A and 6B show a method for reporting that an animal has been found using the system of FIG. 1, according to another embodiment.

FIG. 7 shows a method for searching a database that forms part of the system of FIG. 1, according to another embodiment.

### DETAILED DESCRIPTION

Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description is intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

Currently, the two primary techniques by which an owner of a lost animal is identified are by electronically reading a microchip that has been implanted into the animal and by reading a tattoo on the animal. Both of these techniques have significant drawbacks. For example, implanting a microchip into an animal is an invasive procedure that poses a health risk to that animal; not all people who find a lost animal have access to microchip readers; and not all microchips and microchip readers are compatible with each other. Tattoos suffer from their own problems: they fade over time and can become difficult to read; and tattoo registries are typically limited by jurisdiction, so animals lost in one state, for example, that are found in another often cannot be identified using their tattoos.

The embodiments described herein are directed at methods, systems, and techniques for alerting an owner of an animal. One application of these embodiments is alerting an owner of a lost pet that the pet has been found and can be picked up by the owner. Instead of relying on microchips or tattoos, these embodiments utilize a server that includes a database containing reference profiles of various animals that are generated by the animals' owners and uploaded to the server by the owners before or after the animals are lost. Once a person finds a lost animal, that person can upload animal identification information (“found animal identification information”), such as animal species and breed, to the server. The server then compares the found animal identification information to the reference profiles stored in the database to identify the lost animal, and once the animal is identified the server directly contacts the animal's owner. In certain embodiments, if the server cannot identify the animal by using a local database, the server may search a remote database such as a database maintained by a social network, and additionally or alternatively may broadcast the found animal identification information using, for example, the social network in an attempt to alert the animal's owner or by using another suitable means for widely disseminating the message.

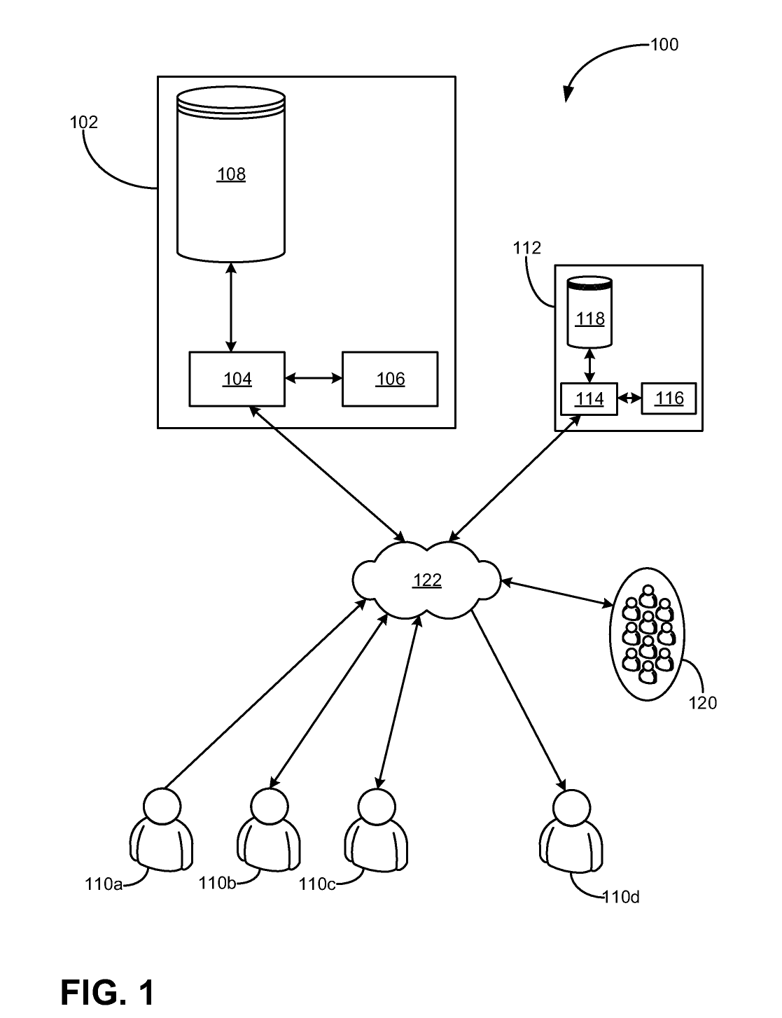

Referring now to FIG. 1, there is shown a system 100 for alerting an owner of an animal, according to one embodiment. The system 100 includes a server 102 that comprises a processor 104, a memory 106, and a database 108. The memory 106 has encoded on it statements and instructions to cause the processor 104 to perform the embodiments of the method described herein. The database 108 has stored in it reference profiles for different animals, the particulars of which are described in more detail below.

The server 102 is communicatively coupled to a network 122 such as the Internet. Via the network 122 the server 102 communicates with various users of the system 100: people who find lost animals (“finders 110a”); animal owners 110b; agencies and societies 110c such as the SPCA, city pounds, and veterinarians; and users interested in performing data mining on the database 108 (“data miners 110d”).

To use the system 100, an animal owner 110b first generates a reference profile for his or her animal. The reference profile contains identifying characteristics of the animal, such as animal type (e.g.: cat or dog), animal breed (e.g.: Tabby, Himalayan), animal fur color, animal eye color, animal size, and biometric information relating to animal facial features (e.g.: the distance between the center of the animal's eyes, the distance between the outer and inner edges of the animal's eyes, the distance between the inner edge of the animal's eyes and tip of its nose, the distance between the centre of the animal's eyes to the top (crown) of its head, the shape of the animal's head, the distance between where the animal's ears meet on its head, the distance between the top of the animal's nose to its upper lip, the distance between the outer edges of the animal's nose, the distance between the top of the animal's nose and the center of its nostril, the distance between the centers of the animal's nostrils, the coloration of the animal's face including any unique color patterns or identifiable markings either breed specific or not). Methods such as Principal Components Analysis, Linear Discriminant Analysis, and Elastic Bunch Graphs may be used to obtain this biometric information. The reference profile also includes animal ownership information describing the owner 110b. Animal ownership information includes the owner 110b's name and contact information such as a phone number or e-mail address, and may also include the owner 110b's street address. The owner 110b's street address can be beneficial in that it also describes the general area where a lost animal is likely to be found, which can accordingly be used as part of the reference profile as well. The owner 110b may generate and send the reference profile to the system 100 using, for example, a mobile communications device such as a smartphone that is running a suitable application.

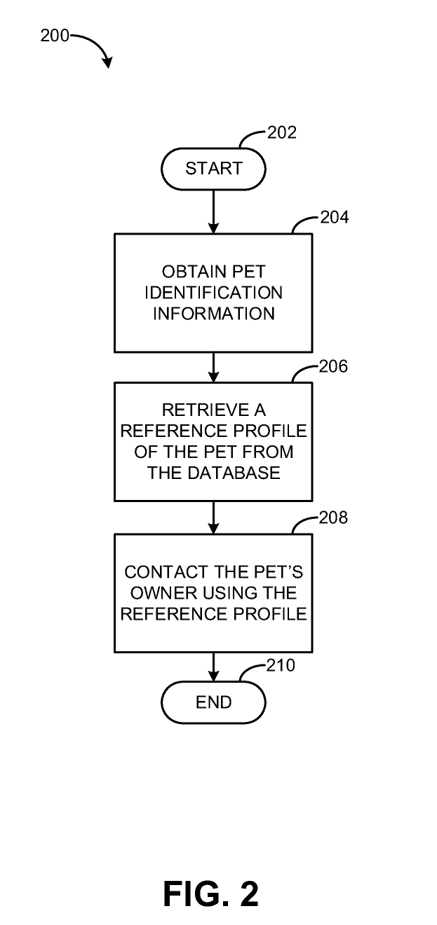

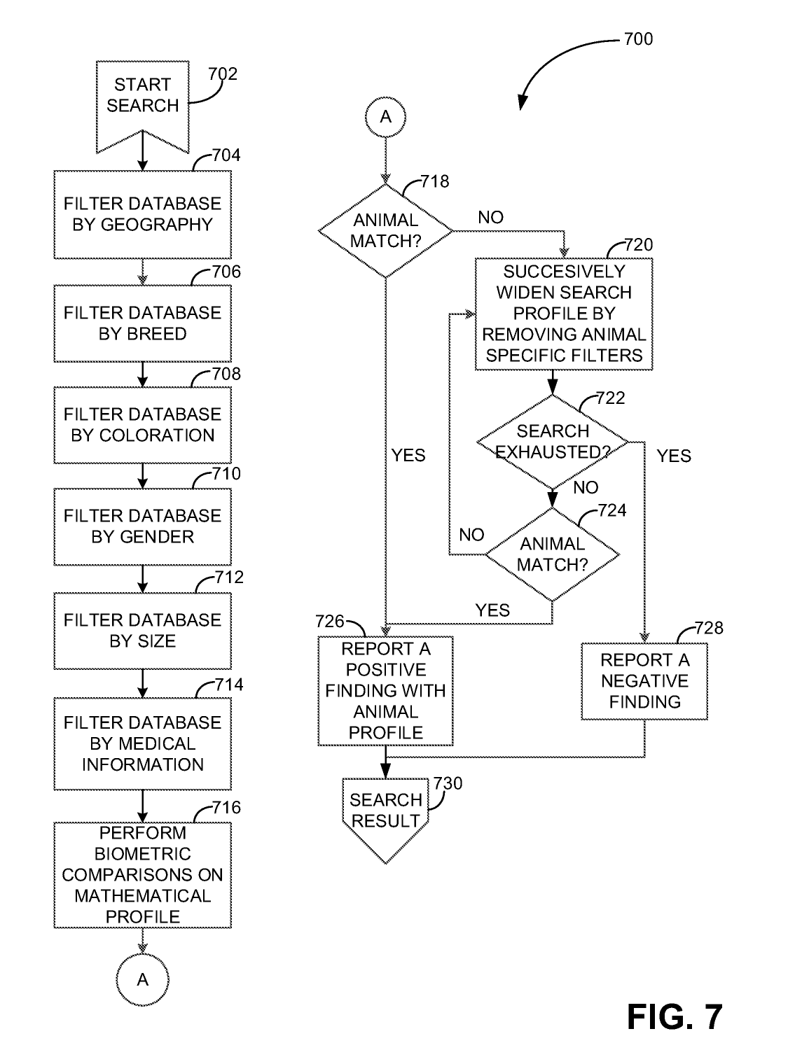

Once the owner 110b has sent the reference profile to the system 100, the system 100 is ready to be used to alert the owner 110b if the owner 110b's animal is found by a finder 110a. Referring now to FIG. 2, there is shown an exemplary method 200, performed by the processor 104, by which the owner 110b may be so alerted. The processor 104 begins performing the method 200 at block 202 and proceeds to block 204. At block 204, the processor 104 obtains found animal identification information about an animal whose owner has lost it but that has been found by a finder 110a. The processor 104 proceeds to block 206 where it uses the found animal identification information to search the database 108 to determine whether any of the animals whose reference profiles are in the database 108 have been found. As discussed in more detail with respect to FIG. 7, below, the animal may be filtered using any one or more of the animal's regular geographic location, breed, sex, colour, size, and weight, for example, prior to attempting to identify the animal using biometric analysis. In the depicted embodiment, to facilitate comparing the found animal to the database of reference profiles, the data fields that comprise the found animal identification information are identical to the data fields that comprise the reference profiles. In alternative embodiments (not depicted), these data fields may differ.

Once the processor 104 retrieves the reference profile for the animal from the database 108, the processor 104 uses the animal ownership information that comprises part of the reference profile to alert the owner 110b that the animal has been found via the network 122. The owner 110b may be alerted in any suitable way: for example, via e-mail, telephone, or text message.

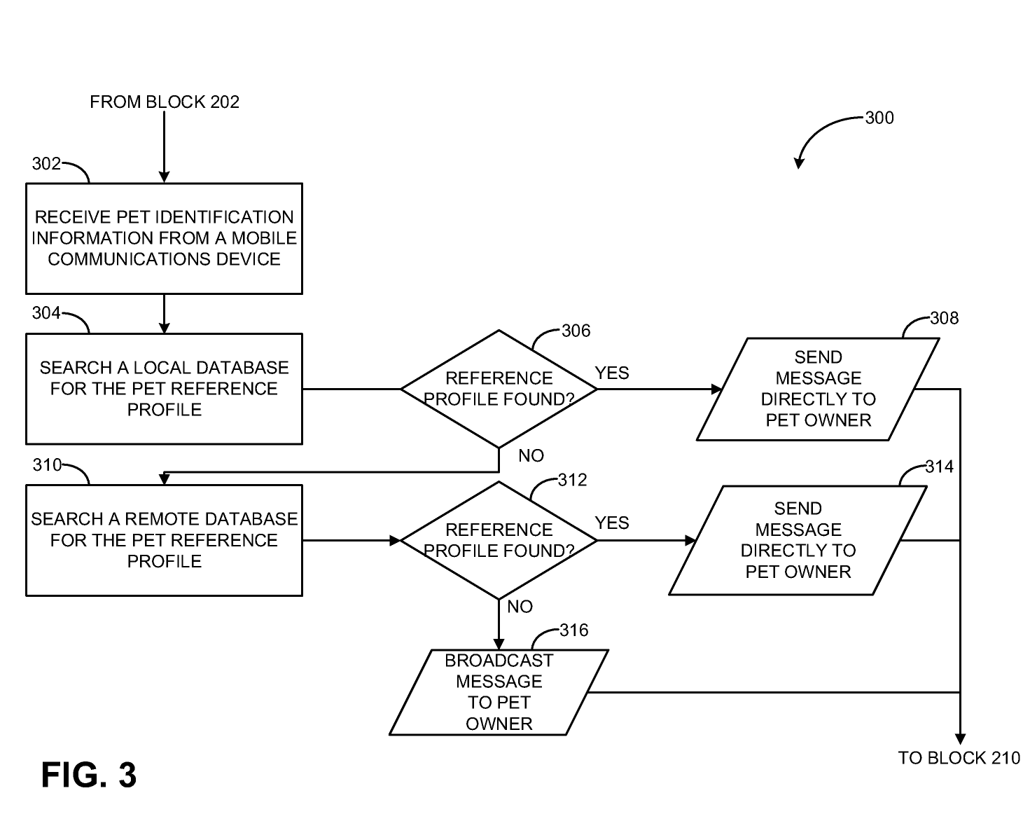

Referring now to FIG. 3, there is shown another exemplary method 300 that the processor 104 may perform when performing blocks 204 to 208 of FIG. 2. At block 302, the processor 104 receives the found animal identification information from a mobile communications device of one of the finders 110a; the finder 110a may generate and send the found animal identification information to the processor 104 using a smartphone application, for example; alternatively, the finder 110a may send raw data such as the photo to the processor 104, which then processes the photo to generate the found animal identification information. After receiving the found animal identification information the processor 104 proceeds to block 304 at which it searches a local database, such as the database 108, for a reference profile whose animal identification information (“reference animal identification information”) matches or sufficiently overlaps with the found animal identification information. A “local database” refers to any database communicatively coupled to the processor 104 either directly or through a local area network. The processor 104 proceeds to block 306 where it determines whether the found animal identification information has been matched to a reference profile stored in the local database. If yes, the processor 104 proceeds to block 308 at which it directly sends a message to the owner 110b alerting the owner that the animal has been found, as discussed above in respect of FIG. 2. If no, the processor 104 proceeds to block 310 at which it searches a remote database for a reference profile whose reference animal identification information matches or sufficiently overlaps with the found animal identification information. A “remote database” refers to any database that is not a local database, and includes databases that the processor 104 accesses via a wide area network such as the network 122. An example of a remote database is a social network database 116 (shown in FIG. 1) that comprises part of a system 112 (shown in FIG. 1) for hosting a social network website, such as Facebook™. As shown in FIG. 1, the system 112 includes the social network database 116, a social network processor 114, and a social network memory 116 communicatively coupled to each other and suitably configured to enable the social network website. Searching the remote database can involve, for example, the processor 104 determining whether any of the social network users 120 is the animal's owner 110b and has posted information in social network forums or applications describing the lost animal. This information, and similar information posted by other social network users 120, constitutes reference profiles for the purposes of the processor 104. If the processor 104 is able to match the found animal identification information to one of the reference profiles from the social network database 116 (block 312), the processor 104 sends a message directly to the animal's owner 110b via, for example, a message sent via the social network website (block 314). If the processor 104 is unable to match the found animal identification information to any reference profiles stored in any remote databases, the processor 104 proceeds to block 316 from block 312 and broadcasts a message with the found animal identification information in an attempt to contact the owner 110b. For example, the processor 104 may post a message to a forum on the social network website using that forum's or social network website's public API, for example, for its users 120 to read in the expectation that one of the users 120 is the owner 110b. Once the processor 104 finishes sending a message to the owner 110b at any of blocks 308, 314, and 316, the processor 104 proceeds to block 210 and the method 200 ends.

Agencies and societies 110c may also use the system 100 both to upload found animal identification information about lost animals that they have collected to find owners 110b, and to upload reference profiles of animals they have found and wish not to lose with those animals' reference animal identification information. In alternative embodiments (not depicted), the agencies and societies 110c may host their own remote databases comprising reference profiles, and the processor 104 may search these remote databases either after searching its own local database as is done in FIG. 3, or simultaneously with searching its own local database.

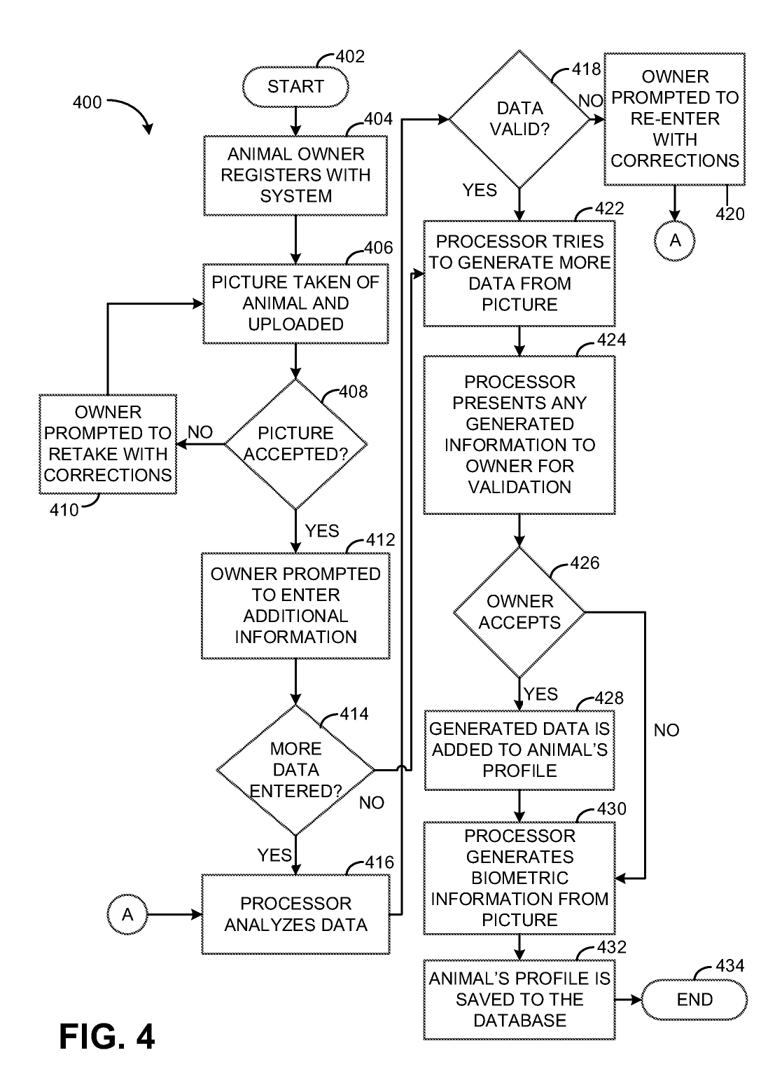

Referring now to FIG. 4, there is shown an embodiment of a method 400 for entering reference animal identification information into the system 100 of FIG. 1. The method 400 begins at block 402 and proceeds to block 404 where the owner 110b registers his animal with the system 100 by creating a reference profile on the server 102. As mentioned above, this reference profile includes the animal ownership information that provides the owner 110b's particulars. At block 406, the owner 110b takes a photo of his animal and uploads it to the processor 104. As discussed above, the owner 110b may do this using, for example, an application running on a smartphone. In the depicted embodiment, the smartphone application includes a grid that helps the owner 110b to properly align the animal's face to facilitate analysis. At block 408 the processor 104 determines whether to accept this photo by comparing it against photo acceptance criteria; exemplary photo acceptance criteria are whether the photo is of sufficient quality, resolution, brightness, and contrast; whether a sufficient proportion of the animal's face is captured within the photo; and if the animal is properly positioned within the grid. The processor 104 acquires the photo to analyze it to generate the reference animal identification information, as discussed in more detail with respect to blocks 422 and 430 below. Accordingly, at block 408 the processor 104 determines whether the photo meets the photo acceptance criteria so that it can act as a source of the reference animal identification information.

If the processor 104 rejects the photo, the processor 104 proceeds to block 410 where it prompts the owner 110b to take another photo, following which the owner 110b takes another photo at block 406 that is then re-evaluated at block 408. If the processor 104 accepts this subsequent photo, the processor 104 proceeds to block 412 where the owner 110b is prompted to enter additional reference animal identification information, if any. For example, the owner 110b may be prompted to enter information such as his address, common locations for the animal (e.g.: neighbor's addresses, daycare, parks), animal breed, fur color, eye color, sex, height, weight, whether the animal has been spayed or neutered, and whether the animal has any distinguishing scars or marks. The processor 104 then proceeds to block 414 where it determines whether the owner 110b entered more reference animal identification information at block 412. If no, the processor 104 proceeds directly to block 422, the function of which is discussed below. If yes, the processor 104 analyzes the additional data the owner 110b provided at block 416. This analysis includes the processor 104 determining whether the additional reference animal identification information is clear, comprehensive (e.g.: whether the owner 110b has populated all the text boxes that the processor 104 has asked to be filled), and whether the processor 104 is able to properly interpret the additional information (e.g.: whether the additional information maps to one of the processor 104's pre-existing data structures). The processor 104 then determines, based on the analysis performed at block 416, whether the additional reference animal identification information provided at block 412 is valid. If not, the processor 104 proceeds to block 420 and prompts the owner 110b to re-enter the information, following which the processor 104 again analyzes the information at block 416. If yes, the processor proceeds to block 422 where it analyzes the photo provided at block 406 in an attempt to generate non-biometric reference animal identification information such as fur color, eye color, breed, sex, and age.

Once the processor 104 has generated this non-biometric reference animal identification information, it proceeds to block 424 where it presents the generated reference animal identification information to the owner 110b for validation. At block 426 the owner 110b reviews the generated reference animal identification information; if the owner 110b accepts it as being accurate, the processor 104 proceeds to block 428 where the generated reference animal identification information is added to the reference profile. Once the generated reference animal identification information has been added to the reference profile, or if the owner 110b rejects the generated reference animal identification information at block 426, the processor 104 proceeds to block 430 where it generates biometric reference animal identification information from the photo. The processor 104 may employ methods such as PCA Principal Components Analysis, LDA Linear Discriminant Analysis, and EBGM Elastic Bunch Graphing to create a mathematical profile of the animal. After generating this biometric reference animal identification information the processor 104 proceeds to block 432 where it updates the animal's reference profile with this additional generated reference animal identification information, following which the method 400 ends at block 434.

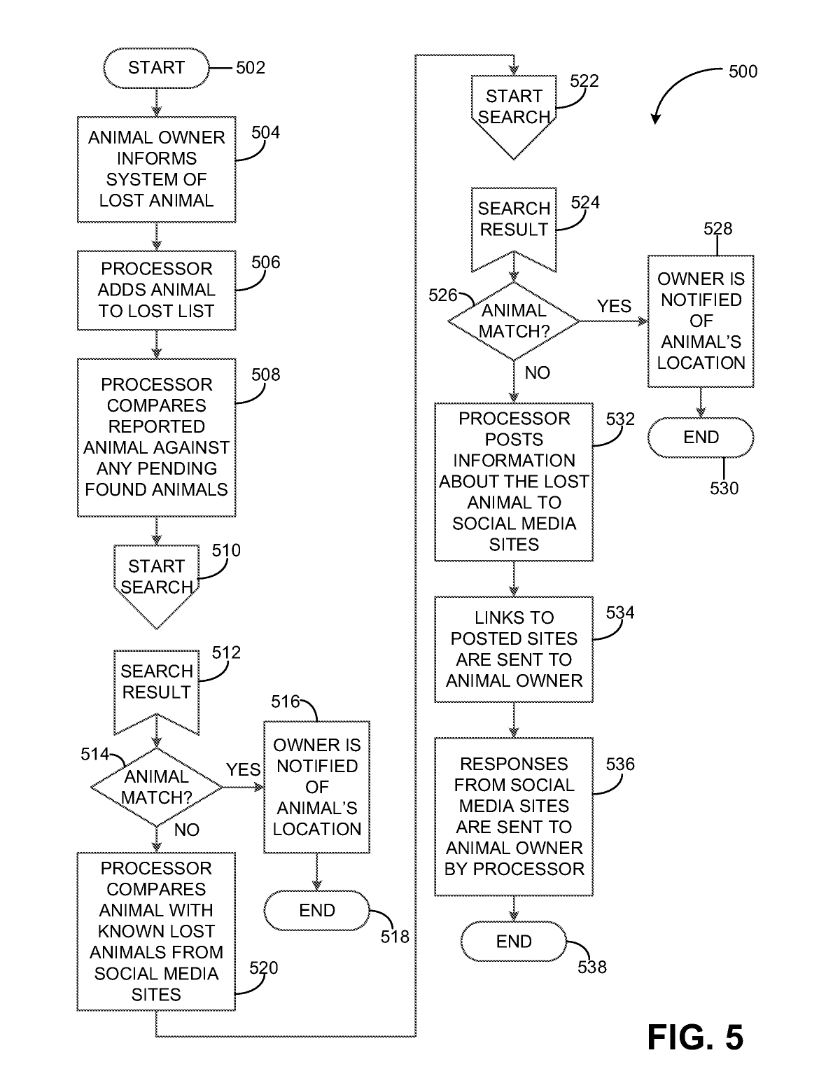

Once the owner 110b has created a reference profile and has populated that reference profile with the reference animal identification information pursuant to the method 400 of FIG. 4, the system 100 is ready to be used to identify a lost animal and to alert that animal's owner 110b. To use the system 100, the lost animal is first reported lost by its owner 110b. Referring now to FIG. 5, there is shown an embodiment of a method 500 for searching a lost animal using the system 100.

The method begins at block 502 and immediately proceeds to block 504. At block 504, the processor 104 receives a notification that the animal's owner 110b has lost an animal (“lost animal”) that has been registered with the system 100 in accordance with the method 400 of FIG. 4. The processor 104 then proceeds to block 506 where it adds the lost animal to a lost list listing all of the lost animals of which the processor 104 is aware; the lost list is a dynamic list of reference profiles of animals that have been reported as lost by their owners 110b. After performing block 506, the processor 104 proceeds to block 508 where it compares the lost list to a list of all the animals various finders 110a have reported to the system 100 as being found (“found list”), which is stored in the database 108. The found list is a dynamic list of reference profiles of animals that have been reported as found by the finders 110a, but which have not yet been matched to one of the owners 110b. The processor 104 compares the two lists at block 510 using the a searching method 700 depicted in FIG. 7, which is discussed in more detail below. The search results are returned at block 512. If the lost animal is in the found list and the processor 104 is able to determine this using the method 700 of FIG. 7, the processor 104 notifies the owner 110b at block 516 by using the animal ownership information, following which the method 500 ends at block 518. If, however, the processor 104 is not able to find the lost animal in the found list, then the processor 104 proceeds to block 520 where it searches a dynamic list of animals that have been reported lost on one or more social networking websites (“social network list”). The social network list may be stored in a local or a remote database, and may be generated in various ways; for example, the system 112 for hosting the social network may generate a list itself and then forward this list to the processor 104. Alternatively, the processor 104 may screen scrape photographs of lost animals from the social networking website (“social network photos”), generate the reference animal identification information from these photographs by employing the methods used in respect of blocks 422 and 430 as described above, and populate its own social network list using this generated reference animal identification information.

Regardless of how the social network list is generated, at block 522 the processor 104 uses the method 700 of FIG. 7 to search the social network list to see if the lost animal is represented in it, and the method 700 returns a result at block 524. If the processor 104 matches the lost animal to an animal in the social network list (block 526), it notifies the animal's owner 110b at block 528 using the animal ownership information and then the method 500 ends at block 530. If the processor 104 is unable to match the lost animal to an animal in the social network list, the processor 104 proceeds to block 532 where it posts some or all of the found animal identification information as links on social network websites for the social network's users 120 to view. The processor 104 also sends the links to the owner 110b (block 534) and forwards any responses to the postings by the social network's users 120 to the owner 110b (block 536); the responses are, at the owner 110b's option, forwarded anonymously. After doing this, the method 500 ends at block 538.

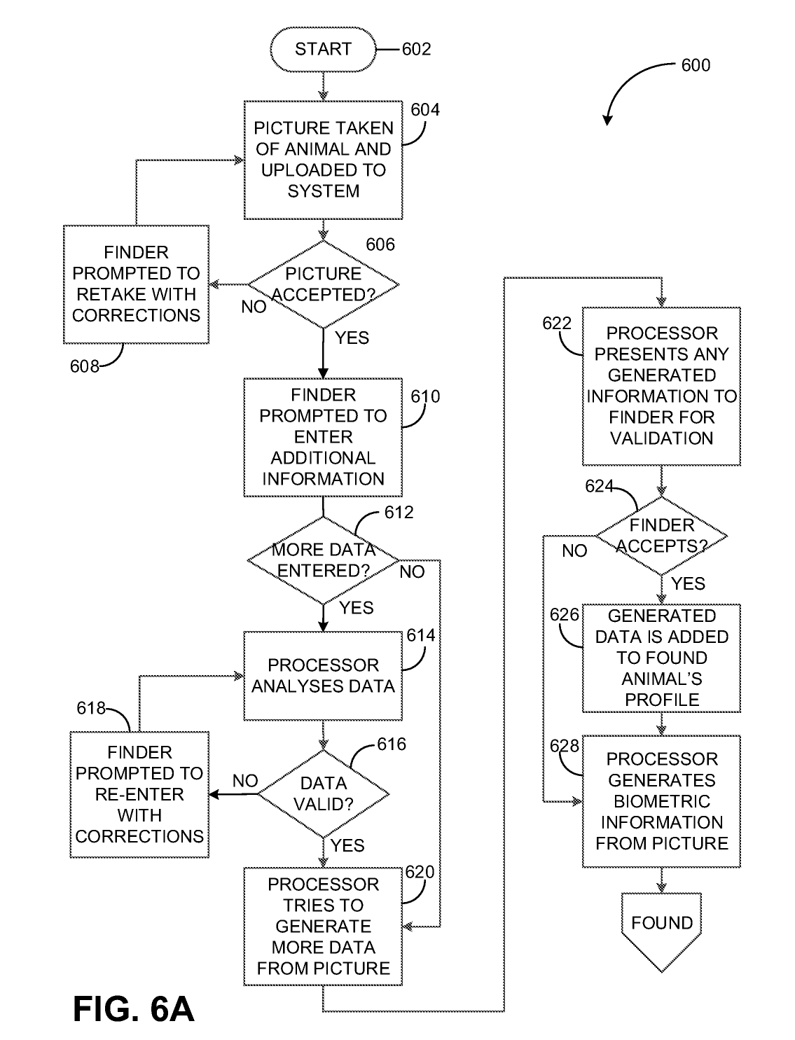

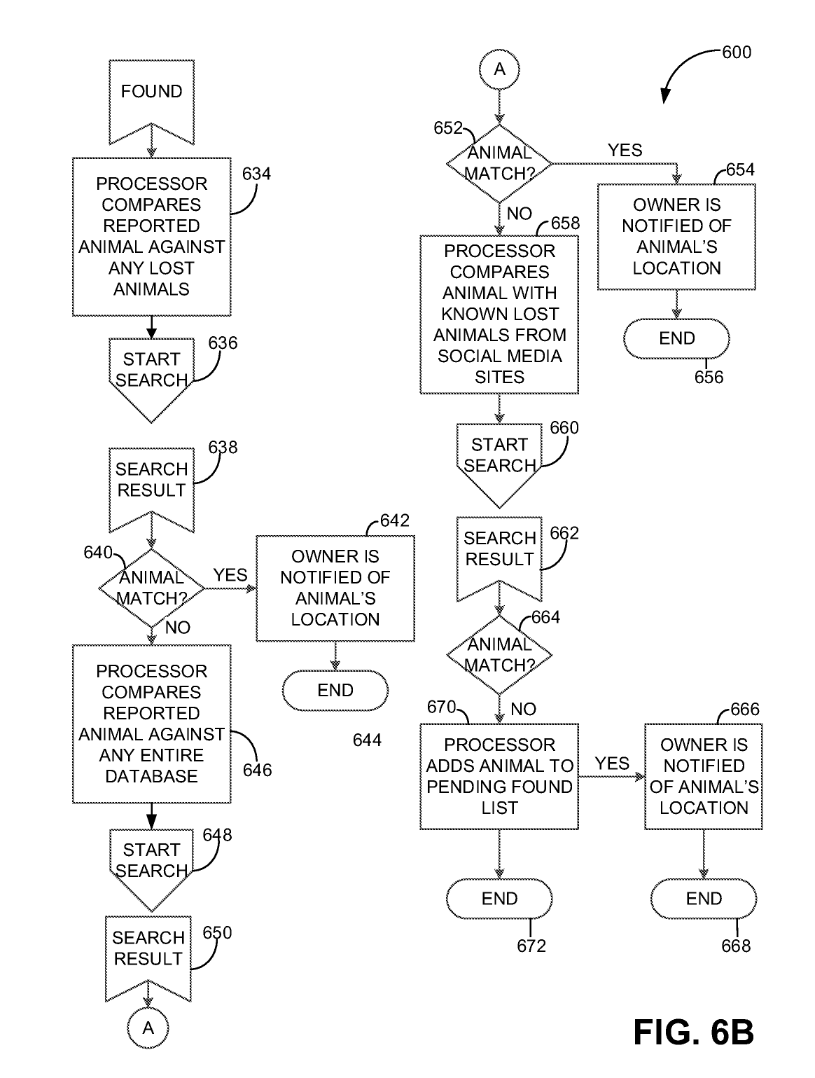

If the processor 104 is unable to match the lost animal that the owner 110b reports to the system 100 in accordance with the method 500 of FIG. 5, the processor 104 waits for one of the finders 110a to, hopefully, find the lost animal and report it to the system 100. An exemplary method 600 that the finders 110a can use to report a lost animal to the system 100 is depicted in FIGS. 6A and 6B.

The method 600 begins at block 602 and proceeds immediately to block 604 where the finder 110a takes a photo of the lost animal and uploads it to the system 100. The finder 110a may do this using, for example, an application running on a smartphone. In the depicted embodiment, the smartphone application includes a grid that helps the finder 110a to properly align the animal's face to facilitate analysis. At block 606 the processor 104 determines whether to accept this photo by comparing it against photo acceptance criteria; exemplary photo acceptance criteria are whether the photo is of sufficient quality, resolution, brightness, and contrast; whether a sufficient proportion of the animal's face is captured within the photo; and if the animal is properly positioned within the grid. The processor 104 acquires the photo to analyze it to obtain the found animal identification information, as discussed in more detail with respect to blocks 620 and 628 below. Accordingly, at block 606 the processor 104 determines whether the photo meets the photo acceptance criteria so that it can act as a source of found animal identification information.

If the processor 104 rejects the photo, the processor 104 proceeds to block 608 where it prompts the finder 110a to take another photo, following which the finder 110a takes another photo at block 604 that is then re-evaluated at block 606. If the processor 104 accepts the photo, the processor 104 proceeds to block 610 where the finder 110a is prompted to enter additional found animal identification information, if any. For example, the finder 110a may be prompted to enter information such as where the animal was found, animal breed, fur color, eye color, sex, height, weight, and whether the animal has any distinguishing scars or marks. The processor 104 then proceeds to block 612 where it determines whether the finder 110a entered more found animal identification information at block 612. If no, the processor 104 proceeds directly to block 620, the function of which is discussed below. If yes, the processor 104 analyzes the additional data the finder 110a provided at block 614. This analysis includes the processor 104 determining whether the additional found animal identification information is clear, comprehensive (e.g.: whether the finder 110a has populated all the text boxes that the processor 104 has asked to be filled), and whether the processor 104 is able to properly interpret the additional information (e.g.: whether the additional information maps to one of the processor 104's pre-existing data structures). The processor 104 then determines, based on the analysis performed at block 614, whether the additional found animal identification information provided at block 610 is valid. If not, the processor 104 proceeds to block 618 and prompts the finder 110a to re-enter the information, following which the processor 104 again analyzes the information at block 614. If yes, the processor proceeds to block 620 where it analyzes the photo provided at block 604 in an attempt to generate non-biometric found animal identification information such as fur color, eye color, breed, sex, and age.

Once the processor 104 has generated this non-biometric found animal identification information, it proceeds to block 622 where it presents the generated found animal identification information to the finder 110a for validation. At block 624 the finder 110a reviews the generated found animal identification information; if the finder 110a accepts the generated found animal identification information as being accurate, the processor 104 proceeds to block 626 where the generated found animal identification information is added to a profile for the found animal (“found animal profile”). Once the generated information has been added to the found animal profile, or if the finder 110a rejects the generated information at block 624, the processor 104 proceeds to block 628 where it generates biometric found animal identification information from the photo. The processor 104 may employ methods such as PCA Principal Components Analysis, LDA Linear Discriminant Analysis, and EBGM Elastic Bunch Graphing to create a mathematical profile of the animal. After generating this biometric found animal identification information, which is added to the found animal profile, the processor 104 proceeds to block 634 where it searches the lost list for a reference profile that comprises reference animal identification information that matches or suitably overlaps the found animal identification information that comprises part of the found animal profile. To perform this search the processor 104 invokes the method 700 of FIG. 7 at block 636, which returns the result of the search at block 638. At block 640 the processor 104 determines whether the method 700 was able to match any of the lost animals in the lost list to the found animal profile. If yes, the processor 104 notifies the animal's owner 110b at block 642 using the animal ownership information, and then proceeds to block 644 where the method 600 ends. If no, the processor 104 then compares the found animal profile to all animals that the owners 110b have registered with the system 100, regardless of whether they have been reported as lost. This comparison is done in the event that one of the animals in the database 108 is lost even if the owner 110b of that animal has not yet reported the animal as lost. At block 648 the processor 104 invokes the method 700 of FIG. 7 to search its entire database 108 of animals, and at block 650 the method 700 returns its results. If the processor 104 determines that the found animal is one of the animals that have been registered with the system 100 (block 652), the processor 104 notifies the owner 110b at block 654, and then the method 600 ends at block 656. If the processor 104 does not match the found animal to any of the animals that have been registered with the system 100, it then compares the found animal to the animals listed in the social network list, as it does at block 520 in the method 500 of FIG. 5. At block 660 the processor 104 again invokes the method 700 of FIG. 7 to perform its search, and the method 700 returns results at block 662. If the found animal is matched to one of the animals in the social network list (block 664), then the processor notifies the found animal's owner 110b at block 666, and the method ends at block 668. If the found animal cannot be matched with an animal in the social network list (block 664), the processor 104 proceeds to block 670 where it adds the found animal to a list of lost animals that have not been matched with their owners 110b (“pending found list”), and the method 600 then ends at block 672.

Referring now to FIG. 7, there is shown an exemplary method 700 for searching a database, such as the local database 108 and the social network database 118, which is invoked by the processor 104 when performing the methods 500,600,700 shown in FIGS. 5 through 7. The method 700 is performed by the processor 104 and begins at block 702, following which the processor 104 filters entries in the database by six different criteria at blocks 704 to 716. At block 704, the processor 104 filters search results by geography, returning only animals whose reference profiles recite the same geographical region as the reference profile of the animal being searched. At block 706, filtering is done by breed, returning only animals whose breed matches the breed of the reference profile of the animal being searched. At block 708, filtering is similarly done based on animal coloration; at block 710, by animal gender; at block 712, by animal size; at block 714, by animal medical information, such as whether the animal has any visible medical conditions; and at block 716, by biometric information. While in the depicted embodiment of the method 700 the processor 104 filters by all of these criteria, in alternative embodiments (not depicted) filtering may be done using more or fewer criteria; for example, in one of these alternative embodiments, the processor 104 does not perform filtering based on biometric information if the filtering done using the non-biometric information from blocks 704 to 714 is sufficient to identify a single animal in the database being searched.

After performing block 716, the processor 104 proceeds to block 718 where it determines whether it has been able to match the found animal identification information that is the subject matter of the search with any of the reference profiles in the database it is searching. If yes, the processor 104 proceeds to block 726 where it reports a positive result with the one or more reference profiles that match the found animal identification information, and it the method 700 ends at block 730. In alternative embodiments (not depicted), the processor 104 may be configured to output only a single search result, such as the reference profile that best matches the found animal identification criteria, or ranked search results that indicate how well various returned reference profiles matched the found animal identification information.

If the processor 104 has been unable to make a match, the processor 104 proceeds to block 720 from 718 where the processor 104 relaxes, or widens, the search criteria by eliminating one or more of the filters applied from blocks 704 to 716. At block 722 the processor 104 checks to ensure that at least one filter criteria remains with which to conduct a search. If after removing one of the filters at block 720 no filter criteria remain, the processor 104 proceeds to block 728 and returns a negative search result, and it outputs this result at block 730. If, however, at least one search criterion remains after block 720, the processor 104 proceeds to block 724 where it searches using all the filter criteria it applied the last time it conducted a search, minus the filter criterion removed at block 720. If this results in a match being made, the processor 104 proceeds to block 726 where it reports a positive result, and the method 700 ends at block 730. If no match is made at block 724, the processor 104 returns to block 720 where it eliminates another of the filter criteria and repeats blocks 722 and 724 until either a match is made or no filter criteria remain.

The processor used in the foregoing embodiments may be, for example, a microprocessor, microcontroller, programmable logic controller, field programmable gate array, or an application-specific integrated circuit. Examples of the computer readable medium 106 are non-transitory and include the memory 106, disc-based media such as CD-ROMs and DVDs, magnetic media such as hard drives and other forms of magnetic disk storage, semiconductor based media such as flash media, random access memory, and read only memory.

FIGS. 2 to 7 are flowcharts of embodiments of exemplary methods. Some of the blocks illustrated in the flowchart may be performed in an order other than that which is described. Also, it should be appreciated that not all of the blocks described in the flow chart are required to be performed, that additional blocks may be added, and that some of the illustrated blocks may be substituted with other blocks.

It is contemplated that any part of any aspect or embodiment discussed in this specification can be implemented or combined with any part of any other aspect or embodiment discussed in this specification.

For the sake of convenience, the exemplary embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A method for alerting an owner of a lost animal, the method comprising:
(a) receiving found animal identification information describing the animal from a person who has found the lost animal;
(b) attempting to retrieve a reference profile of the animal by using the found animal identification information to search a database that comprises the reference profile, wherein the reference profile comprises animal ownership information and reference animal identification information;
(c) when the reference profile is retrieved, contacting the owner of the animal using the animal ownership information; and
(d) when the reference profile is not retrieved, broadcasting a message to attempt to alert the owner of the animal.

2. A method as claimed in claim 1 wherein broadcasting the message comprises placing postings about the animal on a social media website.

3. A method as claimed in claim 1 further comprising:
(a) receiving a photo of the animal;
(b) checking to see whether the photo satisfies photo acceptance criteria;
(c) if the photo satisfies the photo acceptance criteria, generating the reference animal identification information from the photo; and
(d) if the photo does not satisfy the photo acceptance criteria, requesting another photo.

4. A method as claimed in claim 3 further comprising, following generating the reference animal identification information and prior to receiving the found animal identification information:
(a) requesting confirmation that the reference animal identification information is acceptable; and
(b) if the reference animal identification information is acceptable, adding the reference animal identification information to the reference profile of the animal.

5. A method as claimed in claim 1 further comprising:
(a) receiving a notification that the animal is lost; and
(b) adding the animal to a lost list comprising a list of animals that have been lost, wherein the lost list comprises animals whose reference profiles are stored in the database.

6. A method as claimed in claim 5 wherein searching the database comprises searching the lost list to find the reference profile of the animal in the lost list.

7. A method as claimed in claim 5 further comprising:
(a) obtaining photos of lost animals from a social network website (“social network photos”);
(b) generating the reference animal identification information from the social network photos;
(c) generating a social network list comprising a list of animals that have been lost and that have reference profiles populated with the reference animal identification information generated from the social network photos;
and wherein searching the database comprises searching the social network list to find the reference profile in the social network list that comprises the found animal identification information.

8. A method as claimed in claim 7 wherein obtaining the social network photos comprises data scraping the photos from a social network website.

9. A method as claimed in claim 2 further comprising forwarding responses to the postings to the owner.

10. A method as claimed in any claim 1 wherein obtaining the found animal identification information comprises:
(a) receiving a photo of the animal;
(b) checking to see whether the photo satisfies photo acceptance criteria;
(c) if the photo satisfies the photo acceptance criteria, generating the found animal identification information from the photo; and
(d) if the photo does not satisfy the photo acceptance criteria, requesting another photo.

11. A method as claimed in claim 10 further comprising, following generating the found animal identification information:
(a) requesting confirmation that the found animal identification information is acceptable; and
(b) if the found animal identification information is acceptable, using the found animal identification to search the database.

12. A method as claimed in claim 1 wherein the found animal identification information comprises identifying characteristics selected from the group consisting of: animal location, animal type, animal breed, animal fur color, animal eye color, animal size, animal sex, animal height, animal weight, and biometric information relating to pet facial features.

13. A method as claimed in claim 12 wherein the biometric information is selected from the group consisting of: the distance between the center of the animal's eyes, the distance between the outer and inner edges of the animal's eyes, the distance between the inner edge of the animal's eyes and tip of its nose, the distance between the center of the animal's eyes to the top of its head, the shape of the animal's head, the distance between where the animal's ears meet on its head.

14. A method as claimed in claim 1 wherein contacting the owner of the animal comprises sending a message to a mobile communications device registered with the owner.

15. A method as claimed in claim 1 wherein contacting the owner of the animal comprises posting a message to a social network website.

16. A method as claimed in claim 1 wherein the database comprises an online database from a social network website.

17. A method as claimed in claim 1 wherein searching the database comprises filtering reference profiles in the database by all categories of the animal identification information.

18. A method as claimed in claim 1 wherein searching the database comprises filtering reference profiles in the database by successively decreasing categories of the animal identification information until the reference profile of the animal is identified.

19. A system for alerting an owner of an animal, the system comprising:
(a) a processor;
(b) a database communicatively coupled to the processor and having stored therein a reference profile of the animal, wherein the database is searchable using found animal identification information and wherein the reference profile comprises animal ownership information and reference animal identification information; and
(c) a memory communicatively coupled to the processor and having encoded thereon statements and instructions to cause the processor to perform a method comprising:
(i) receiving the found animal identification information describing the animal from a person who has found the lost animal;
(ii) attempting to retrieve the reference profile of the animal by using the found animal identification information to search the database;
(iii) when the reference profile is retrieved, contacting the owner of the animal using the animal ownership information; and
(iv) when the reference profile is not retrieved, broadcasting a message to attempt to alert the owner of the animal.

20. A non-transitory computer readable medium having encoded thereon statements and instructions to cause a processor to perform a method for alerting an owner of an animal, the method comprising:
(a) receiving found animal identification information describing the animal from a person who has found the lost animal;
(b) attempting to retrieve a reference profile of the animal by using the found animal identification information to search a database that comprises the reference profile, wherein the reference profile comprises animal ownership information and reference animal identification information;
(c) when the reference profile is retrieved, contacting the owner of the animal using the animal ownership information; and
(d) when the reference profile is not retrieved, broadcasting a message to attempt to alert the owner of the animal.
